(19) United States
(12) Patent Application Publication
(10) Pub. No.: US 2017/0020143 A1
(43) Pub. Date: Jan. 26, 2017

(54) Heat-Treated Flour

(71) Applicant: Rich Products Corporation, Buffalo, NY (US)

(72) Inventor: John S. Roberts, Buffalo, NY (US)

(73) Assignee: Rich Products Corporation

(21) Appl. No.: 15/285,695

(22) Filed: Oct. 5, 2016

Related U.S. Application Data
(62) Division of application No. 14/208,867, filed on Mar. 13, 2014.
(60) Provisional application No. 61/782,801, filed on Mar. 14, 2013.

(51) Int. Cl. A21D 6/00; A21D 13/04

(52) U.S. Cl. CPC A21D 6/003; A21D 6/001; A21D 13/04

(57) ABSTRACT

An improved method for heat treating flour. The resulting flour has increased moisture absorption and increased strength. Dough made from the heat-treated flour has improved performance, and baked goods made from the heat-treated flour have improved properties relative to dough and baked goods made from untreated flour.

The present invention is a divisional application of U.S. Ser. No. 14/208,867 filed Mar. 13, 2014, which in turn claims priority on U.S. Provisional Application Ser. No. 61/782,801 filed Mar. 14, 2013, which is incorporated herein by reference.

The present invention relates generally to the field of the treating of flour, more particularly to the treating of flour to improve water absorption capacity, dough handling, baking quality of the flour, and/or to improve the performance of the flour, and still more particularly to the heating of the flour to improve water absorption capacity, dough handling, baking quality of flour, and/or to improve the performance of the flour. The present invention also relates to products formed from the heat-treated flour.

### BACKGROUND OF THE INVENTION

Heat treatment of flour or wheat has been carried out in the art for various purposes. For example, Japiske et al. (U.S. Pat. No. 3,159,493) discloses subjecting the flour to temperatures of 260-310° F. in an atmosphere containing water vapor under elevated pressure for 1-10 minutes to eliminate microorganism contaminants in flour with a minimum irreversible change in the physiochemical properties of flour. This reference is incorporated herein by reference.

Hatton et al. (U.S. Pat. No. 3,428,461) discloses the treatment of flour at temperatures of 150-360° F. in an atmosphere with greater than 40% relative humidity for 10-80 minutes to make the treated flour useful in culinary mixes. This reference is incorporated herein by reference.

Bush et al. (U.S. Pat. No. 4,937,087) discloses the heat treatment of farina at 300-600° F. for 30-180 seconds to reduce the moisture content of the farina such that 10% of the starch is gelatinized. This reference is incorporated herein by reference.

Upreti et al. (U.S. Pat. No. 8,574,657) discloses the heat treatment of flour using a two-step heating process that includes the steps of first dehydrating the flour to minimize or avoid gelatinization, and then heat treating the dehydrated flour. This reference is incorporated herein by reference.

### SUMMARY OF THE INVENTION

The present invention is directed to an improved flour and a method for manufacturing the improved flour to improve water absorption capacity, dough handling, baking quality of the flour, and/or to improve the performance of the flour. In particular, the present invention is directed to a heat-treated flour having improved properties and a method for preparing the same. In summary, the present invention is directed to a heat-treated flour having improved properties and a method for preparing the same. The invention provides a method for increasing the water absorptive capacity of the flour without compromising the baking performance of dough made from the treated flour. The method of heat treating flour of the invention includes the step of heating and dehydrating flour. The method of heat treating flour of the invention includes the step of heating flour while minimizing gelatinization; however, this is not required.

In one non-limiting aspect of the present invention, there is provided a method for heat-treating flour comprising the steps of: a) providing a flour; b) thermally heating the flour in a single heat treating step such that the moisture content of the flour is reduced to 1-6% and any value or range therebetween (e.g., 1%, 1.01%, 1.02% . . . 5.98%, 5.99%, 6%); and c) cooling the heat-treated flour in an environment that minimizes reabsorption of moisture into the flour. The heat-treated flour exhibits an increase in moisture absorption of at least 2% (e.g., 2%, 2.01%, 2.02% . . . 14.985, 14.99%, 15% and any value or range therebetween) relative to untreated flour. In one non-limiting embodiment of the invention, the flour is thermally heated in one or more heat exchangers. The one or more heat exchangers can be heated by heated liquid (e.g., steam, heated water, etc.) flowing through one or more coils or chambers in the heat exchanger and/or electric heating coils; however, this is not required. In another and/or alternative non-limiting embodiment of the invention, the flour continuously flows through the one or more heat exchangers. The flowrate of the flour through the one or more heat exchangers is non-limiting. Generally, the flowrate is about 1-200,000 lbs/hr and any value or range therebetween (e.g., 1 lbs/hr, 1.1 lbs/hr, 1.2 lbs/hr . . . 199,999.8 lbs/hr, 199,999.9 lbs/hr, 200,000 lbs/hr) through the one or more heat exchangers, typically about 100-100,000 lbs./hr., more typically about 2,000-50,000 lbs./hr., and still more typically about 4,000-40,000 lbs./hr. The length of the one or more heat exchangers and the flowrate of the flour through the one or more heat exchangers is selected so that the residence time of the flour in the one or more heat exchangers is about 0.1-60 minutes and any value or range therebetween (e.g., 0.1 min., 0.11 min., 0.12 min. . . . 59.98 min, 59.99 min. 60 min.), typically about 0.2-40 minutes, and more typically about 0.5-20 minutes. The maximum temperature of the one or more heat exchangers is about 200° F.-380° F. and any value or range therebetween (e.g., 200° F., 200.1° F., 200.2° F. . . . 379.8° F., 379.9° F., 380° F.), and typically about 260° F.-350° F. The average humidity level in the one or more heat exchangers is about 2-30% and any value or range therebetween (e.g., 1%, 2.01%, 2.02% . . . 29.98%, 29.99%, 30%). Generally, no forced air flows through the one or more heat exchangers during the heating of the flour; however, this is not required. Generally, air is naturally drawn into the one or more heat exchangers as the flour flows into the one or more heat exchangers.

In another and/or alternative non-limiting aspect of the present invention, there is provided a method for heat treating flour comprising the steps of: a) providing a flour at ambient temperature (65° F.-85° F.) and having a moisture content of about 6%-18% (e.g., 6%, 6.01%, 6.02% . . . 17.98%, 17.99%, 18% and any value or range therebetween; b) thermally heating the flour in a single heat-treating step such that the moisture content of the flour is reduced to 1%-5% (e.g., 1%, 1.01%, 1.02% . . . 4.98%, 4.99%, 5% and any value or range therebetween); c) controlling the heating temperature and the residence time of the flour in the heating system such that the heat-treated flour exits the heat-treating step at a temperature of at least about 200° F. (e.g., 200° F., 200.1° F., 200.2° F. . . . 349.8° F., 349.9° F., 350° F. and any value or range therebetween); and d) cooling the heat-treated flour to ambient temperature in an environment that minimizes reabsorption of moisture into the flour such that the percentage increase in moisture of the heat-treated flour is no more than about 40% (e.g., 0%, 0.01%, 0.02% . . . 39.98%, 39.99%, 40% and any value or range therebetween) and/or the weight percent moisture increase is no more than about 3% (e.g., 0%, 0.01%, 0.02% . . . 2.98%, 2.99%, 3% and any value or range therebetween), and the final moisture content of the cooled heat-treated flour is about 1-7% (e.g., 1%, 1.01%, 1.02% . . . 6.98%, 6.99%, 7% and any value or range therebetween).

In still another and/or alternative non-limiting aspect of the present invention, the amount of denatured protein in the heat-treated flour that is caused by the heat-treatment process is greater than about 5% and less than about 30% (e.g., 5.01%, 5.02% . . . 29.98%, 29.99%, 30% and any value or range therebetween), and generally about 7%-20% (e.g., 7%, 7.01%, 7.01% . . . 19.98%, 19.99%, 20% and any value or range therebetween) of the heat-treated flour includes denatured protein.

In yet another and/or alternative non-limiting aspect of the present invention, the flour after heating has a particle size distribution such that greater than 50% (e.g., 50.01%, 50.02% . . . 99.98%, 99.99%, 100% and any value or range therebetween) of the flour has particles from about 90-150 microns (e.g., 90 microns, 90.01 microns, 90.02 microns . . . 149.98 microns, 149.99 microns, 150 microns and any value or range therebetween). In one non-limiting embodiment of the invention, at least 75% of the flour after heating has particles from about 90-150 microns. In another non-limiting embodiment of the invention, at least 80% of the flour after heating has particles from about 90-150 microns. In another non-limiting embodiment of the invention, at least 5% (e.g., 5%, 5.01%, 5.02% . . . 49.98%, 49.99%, 50% and any value or range therebetween) of the flour, prior to heating has particles from about 150-250 microns (e.g., 150 microns, 150.01 microns, 150.02 microns . . . 249.98 microns, 249.99 microns, 250 microns and any value or range therebetween).

In yet another and/or alternative non-limiting aspect of the present invention, dough that is partially or fully formed from the heat-treated flour of the present invention exhibits improved performance, and/or baked goods made from heat-treated flour exhibits improved properties. In one non-limiting embodiment of the present invention, a dough made from flour heat-treated according to the present method exhibits at least 3% (e.g., 3%, 3.01%, 3.02% . . . 24.98%, 24.99%, 25% and any value or range therebetween) reduced stickiness and/or at least 3% (e.g., 3%, 3.01%, 3.02% . . . 24.98%, 24.99%, 25% and any value or range therebetween) reduced adhesiveness and/or at least 3% (e.g., 3%, 3.01%, 3.02% . . . 24.98%, 24.99%, 25% and any value or range therebetween) increased strength compared to dough made from untreated flour.

In yet another and/or alternative non-limiting aspect of the present invention, the first step in the process of the present invention is to remove moisture from the flour. This moisture removal step occurs in a single processing step. After the moisture removal step, the starch granules are intact and discernible, which is indicative of a lack of gelatinization; however, this is not required. Generally, less than 10% (e.g., 0%, 0.01%, 0.02% . . . 9.98%, 9.99%, 10% and any value or range therebetween) of the starch in the flour is gelatinized. During the moisture removal step, the moisture content of the flour is reduced from about 10%-15% (e.g., 10%, 10.01%, 10.02% . . . 14.98%, 14.99%, 15% and any value or range therebetween) by weight of the flour to about 1%-6% (e.g., 1%, 1.01%, 1.02% . . . 5.98%, 5.99%, 6% and any value or range therebetween) by weight of the flour. Generally, the moisture content of the flour is not less than about 1%, generally not less than about 1.1%, typically not less than about 1.2%, and more typically not less than about 1.5%. The reducing of the moisture to less than about 1% can result in poor dough formation and baked products with unacceptable quality and low BSV; however, this is not required. Generally, the moisture removal step occurs in a heat exchanger using indirect heating; however, other or additional moisture removal methods can be used. Generally, the flour during the moisture removal step is continuously flowed through the heating device; however, this is not required. The flour is generally not preheated prior to being flowed through the heating device such that ambient temperature flour is initially introduced to the heating device; however, this is not required. The maximum temperature that the flour is exposed to as the flour flows through the heating device is generally about 250° F.-380° F. (e.g., 250° F., 250.01° F., 250.02° F. . . . 379.98° F., 379.99° F., 380° F. and any value or range therebetween), and typically about 280° F.-330° F.; however, this is not required. The flow rate of the flour through the heating device is generally about 100-50,000 lbs/hr (e.g., 100 lbs/hr, 100.1 lbs/hr, 100.2 lbs/hr 49,999.8 lbs/hr, 49,999.9 lbs/hr, 50,000 lbs/hr and any value or range therebetween); however, this is not required. A conveyor belt, auger, blower, or the like can be used to facilitate in the partial or full transport of the flour through the heating device; however, this is not required. The residence time of the flour in the heating device is generally at least about 30 seconds (e.g., 30 sec, 30.01 sec, 30.02 sec . . . 29.998 min, 29.999 min, 30 min, and any value or range therebetween), typically at least about 1 minute, and more typically at least about 2-4 minutes. The residence time of the flour in the heating device is generally less than about 30 minutes, typically less than about 20 minutes, and more typically generally less than about 15 minutes. After the flour has been heated, the flour is cooled to ambient temperature. Generally, the moisture content of the heat-treated flour includes in moisture content no more than about 5% by weight (e.g., 1 wt %, 1.01 wt %, 1.02 wt % . . . 4.98 wt %, 4.99 wt %, 5 wt % and any value or range therebetween), typically no more than about 3% by weight, an even more typically no more than about 1-3% by weight.

In still yet another and/or alternative non-limiting aspect of the present invention, additives can be added to the flour before, during and/or after the heat treatment; however, this is not required. Examples of such additives include, but are not limited to, vitamins, minerals, salts, flavors and enzymes.

In another and/or alternative non-limiting aspect of the present invention, the heat treatment of the present invention results in at least 5% (e.g., 5%, 5.01%, 5.02% . . . 4.98%, 14.99%, 15% and any value or range therebetween) of the protein in the flour being denatured, as determined by the amount of acid-soluble protein measured by the gluten denaturation test described by Orth and Bushek (Cereal Chem., 49:268 (1972)). This test measures denaturation of gluten by measuring the loss of protein in dilute acetic acid. In one non-limiting embodiment of the invention, about 7% to 15% of the protein is denatured. “Protein” as used herein refers to all proteins present in the flour (e.g., gliadin, glutenin, etc.).

In still another and/or alternative non-limiting aspect of the present invention, the treatment process of the present invention can result in flour with a particle-size distribution which is different from the particle-size distribution of flour which has not been so treated. In one non-limiting embodiment, at least 80% (e.g., 80%400% and any value or range therebetween) of the particles of the heat-treated flour are from about 90-150 microns in size, and any value or range therebetween. In another non-limiting embodiment, at least 80% (e.g., 80%-93% and any value or range therebetween) of the particles of the heat-treated flour are from about 90-150 microns in size, and at least about 7% (e.g., 2%-20% and any value or range therebetween) of the particles are from 150-250 microns and any value or range therebetween.

In yet another and/or alternative non-limiting aspect of the present invention, the heat-treated flour has a decreased microbial load relative to untreated flour.

In still yet another and/or alternative non-limiting aspect of the present invention, the heat-treated flour has an A_{w} of about 0.1-0.5 (e.g., 0.1, 0.101, 0.102 . . . 0.498, 0.499, 0.5 and any value or range therebetween), typically about 0.25-0.45, and more typically about 0.3-0.35.

In another and/or alternative non-limiting aspect of the present invention, the types of flour that can be heat-treated in the present invention generally are flour based on cereal grains. Non-limiting examples of such flour include, but are not limited to, whole wheat, soft or hard wheat, durum wheat, barley, rice, and potato flours, and mixtures thereof. Both flour with gluten-forming proteins (e.g., wheat flour, etc.) and flour without gluten-forming proteins (e.g., include, but are not limited to, rice, tapioca, potato flour, corn, sorghum flour, buckwheat flour, millet flour, flax flour, pea flour, oat flour, soy flour, etc.). Flour of any grade or flour or meal obtained at any stage of the milling process can be subjected to heat treatment according to the present invention. The flour generally has a moisture content of at least about 6% and generally about 6% to 18% (e.g., 6%, 6.01%, 6.02% . . . 17.98%, 17.99%, 18% and all values and ranges therebetween).

In still another and/or alternative non-limiting aspect of the present invention, the heat-treated flour according to the present invention can be used to make dough. The dough may or may not be frozen. A non-limiting example of a dough useful in the present invention includes flour, water, leavening agent (which may be yeast or chemical leavening agent or both) and, optionally, one or more additional ingredients including, for example, iron, salt, stabilizer(s), flavored oils, enzymes, sugar, niacin, at least one fat source, riboflavin, corn meal, thiamine mononitrate, flavoring(s), and the like. A dough formulation and method are described in U.S. Patent Publication Nos. 2007/0160709 and 2010/0092639, which dough formulation and method are incorporated herein by reference.

In yet another and/or alternative non-limiting aspect of the present invention, the present invention provides flour with improved properties. These improved properties include, but are not limited to, properties of the flour itself, properties of dough (including frozen dough) made from the heat-treated flour, and/or baking properties of the dough (including frozen dough). Non-limiting examples of such properties include increased moisture absorption, increased strength, decreased adhesiveness, decreased stickiness and/or decreased cohesiveness. In manufacturing processes, decreased stickiness is advantageous in that processing throughput is increased as less material sticks to the manufacturing equipment. For example, high-moisture dough prepared with heat-treated flour can be processed. The moisture absorption, increased strength, shelf-life, tolerance index and/or adhesiveness of dough made from the heat-treated flour of the present invention can be improved as compared to dough made from nonheat-treated flour. Baked products prepared from the heat-treated flour of the present invention can have desirable properties (e.g., baked specific volume) relative to those prepared from flour which has not been heat-treated. Baked products formed partially or fully from dough that includes the heat-treated flour of the present invention can have the same or higher baked specific volume and/or lower percent solids as compared to baked products made from dough that does not include heat-treated flour.

It is one non-limiting object of the present invention to provide an apparatus, system, process and/or method for heat treating flour.

It is another and/or alternative non-limiting object of the present invention to produce products that are at least partially formed from heat-treated flour.

It is still another and/or alternative non-limiting object of the present invention to provide an apparatus, system, process and/or method for heat treating flour to improve water absorption capacity, dough handling, baking quality of flour, and/or to improve the performance of the flour.

It is yet another and/or alternative non-limiting object of the present invention to provide an apparatus, system, process and/or method for heat treating flour for increasing the water absorptive capacity of flour without compromising the baking performance of dough made from the treated flour.

It is still yet another and/or alternative non-limiting object of the present invention to provide an apparatus, system, process and/or method for heat treating flour that includes the steps of heating and dehydrating flour.

It is another and/or alternative non-limiting object of the present invention to provide an apparatus, system, process and/or method for heat treating flour that includes the steps of a) providing a flour; b) thermally heating the flour in a single heat-treating step such that the moisture content of the flour is reduced to 1-6%; and c) cooling the heat-treated flour in an environment that minimizes reabsorption of moisture into the flour.

It is still another and/or alternative non-limiting object of the present invention to provide an apparatus, system, process and/or method for heat treating flour that includes the steps of a) providing a flour at ambient temperature (65° F.-85° F.) and having a moisture content of about 6%-18%; b) thermally heating the flour in a single heat-treating step such that the moisture content of the flour is reduced to 1%-5%; c) controlling the heating temperature and the residence time of the flour in the heating system such that the heat-treated flour exits the heat-treating step at a temperature of at least about 200° F.; and d) cooling the heat-treated flour to ambient temperature in an environment that minimizes reabsorption of moisture into the flour such that the percentage increase in moisture of the heat-treated flour is no more than about 40% and/or the weight percent moisture increase is no more than about 3%, and the final moisture content of the cooled heat-treated flour is about 1-7%.

It is yet another and/or alternative non-limiting object of the present invention to provide an apparatus, system, process and/or method for heat treating flour that minimizes gelatinization of the flour.

It is still yet another and/or alternative non-limiting object of the present invention to provide an apparatus, system, process and/or method for heat treating flour that products heat-treated flour that exhibits an increase in moisture absorption of at least 2% relative to untreated flour.

It is another and/or alternative non-limiting object of the present invention to provide an apparatus, system, process and/or method for heat treating flour that is thermally heated in one or more heat exchangers.

It is still another and/or alternative non-limiting object of the present invention to provide an apparatus, system, process and/or method for heat treating flour that continuously flows flour through one or more heat exchangers.

It is yet another and/or alternative non-limiting object of the present invention to provide an apparatus, system, process and/or method for heat treating flour that denatures protein in the heat-treated flour in amount that is greater than about 5% and less than about 30%.

It is still yet another and/or alternative non-limiting object of the present invention to provide an apparatus, system, process and/or method for heat treating flour that after heating the flour has a particle size distribution such that greater than 50% of the flour has particles from about 90-150 microns.

It is another and/or alternative non-limiting object of the present invention to provide an apparatus, system, process and/or method for heat treating flour that at least 5% of the flour prior to heating has particles from about 150-250 microns.

It is still another and/or alternative non-limiting object of the present invention to provide an apparatus, system, process and/or method for heat treating flour wherein a dough that is at least partially formed from the heat-treated flour exhibits at least 3% reduced stickiness and/or at least 3% reduced adhesiveness and/or at least 3% increased strength compared to dough made from untreated flour.

It is yet another and/or alternative non-limiting object of the present invention to provide an apparatus, system, process and/or method for heat treating flour wherein additives can be added to the flour before, during and/or after the heat treatment.

It is still yet another and/or alternative non-limiting object of the present invention to provide an apparatus, system, process and/or method for heat treating flour wherein at least 5% of the protein in the flour is denatured.

It is another and/or alternative non-limiting object of the present invention to provide an apparatus, system, process and/or method for heat treating flour wherein the heat-treated flour has a decreased microbial load relative to untreated flour.

It is still another and/or alternative non-limiting object of the present invention to provide an apparatus, system, process and/or method for heat treating flour wherein the heat-treated flour has an A_{w} of about 0.1-0.5.

These and other objects and advantages will become apparent to those skilled in the art upon the reading and following of this description taken together with the accompanying drawings.

### BRIEF DESCRIPTION OF THE DRAWINGS

Reference may now be made to the drawings, which illustrate various embodiments that the invention may take in physical form and in certain parts and arrangements of parts wherein;

FIG. 1 illustrates whole and cut whole wheat rolls formed with use of and formed without use of the heat-treated flour of the present invention;

FIG. 2 is a graph illustrating the baked specific volume of the baked whole wheat rolls illustrated in FIG. 1 as a function of the time period the dough was frozen prior to the baking of the whole wheat rolls;

FIG. 3 illustrates cut sweet rolls formed with use of and formed without use of the heat-treated flour of the present invention;

FIG. 4 is a graph illustrating the baked specific volume of the baked sweet rolls illustrated in FIG. 3 as a function of the time period the dough was frozen prior to the baking of the sweet rolls;

FIGS. 5 and 6 illustrate a whole and cut whole wheat bread loaf formed with use of and formed without use of the heat-treated flour of the present invention;

FIG. 7 is a graph illustrating the baked specific volume of the baked whole wheat bread loaves illustrated in FIGS. 5 and 6 as a function of the time period the dough was frozen prior to the baking of the whole wheat bread loaves;

FIGS. 8 and 9 illustrate whole and cut whole wheat bread loaves formed with use of and formed without use of the heat-treated flour of the present invention;

FIG. 10 illustrates cut fresh bake whole wheat bread slices formed with use of and formed without use of the heat-treated flour of the present invention;

FIG. 11 is a non-limiting process for manufacturing the heat-treated flour of the present invention; and,

FIG. 12 illustrates non-limiting processing equipment that can be used to manufacture the heat-treated flour of the present invention.

### DESCRIPTION OF NON-LIMITING EMBODIMENTS OF THE INVENTION

Referring now in greater detail to the drawings, wherein the showings are for the purpose of illustrating various embodiments of the invention only, and not for the purpose of limiting the invention, the present invention is directed to the heat treating of flour to improve water absorption capacity, dough handling, baking quality of flour, and/or to improve the performance of the flour, and to food products made from the heat-treated flour.

The heat-treated flour exhibits improved performance and the baked goods made from the heat-treated flour exhibit improved properties. A dough that is at least partially made from the heat-treated flour of the present invention exhibits at least 3% reduced stickiness, at least 3% reduced adhesiveness, and/or at least 3% increased strength as compared to dough made from untreated flour.

One non-limiting method for heat-treating flour in accordance with the present invention comprising the steps of:

a) providing a flour;

b) thermally heating the flour in a single heat treating step such that the moisture content of the flour is reduced to 1-6%; and,

c) cooling the heat-treated flour in an environment that minimizes reabsorption of moisture into the flour.

Another non-limiting method for heat-treating flour in accordance with the present invention comprising the steps of:

a) providing a flour at ambient temperature (65° F.-85° F.), and which flour has a moisture content of about 6%-18%;

b) thermally heating the flour in a single heat-treating step such that the moisture content of the flour is reduced to about 1%-5%;

c) controlling the heating temperature and the residence time of the flour in the heating system during the step of thermally heating the flour such that the heat-treated flour exits the heating system at a temperature of about 200° F.-340° F.; and,

d) cooling the heat-treated flour to ambient temperature in an environment that minimizes reabsorption of moisture into the heat-treated flour such that the percentage increase in moisture of the heat-treated flour is no more than about 30% and/or the weight percent moisture increase is no more than about 3%, and the final moisture content of the cooled heat-treated flour is about 1-7%.

The source of the flour used in the method of the present invention includes, but is not limited to, one or more sources selected from soft or hard wheat, durum wheat, barley, rice, and potato flours, and mixtures thereof. Both flour with gluten-forming proteins (e.g., wheat flour, etc.) and flour without gluten-forming proteins (e.g., rice, tapioca, potato flour, etc.) can be used in the present invention. The average particle size distribution of the flour prior to being heat-treated is such that generally at least 2%-50% of the flour has particles from about 150-250 microns.

The step of thermally heating the flour generally occurs using indirect heating. One type of indirect heat that can be used is the use of one or more heat exchangers to heat treat the flour. When the flour is continuously flowed through the one or more heat exchangers, the flow rate of the flour typically is about 2,000-50,000 lbs./hr. The length of the one or more heat exchangers and the flow rate of the flour through the one or more heat exchangers is generally selected so that the residence time of the flour in the one or more heat exchangers during the complete heating process is about 0.2-40 minutes. The maximum temperature of the one or more heat exchangers is generally about 260° F.-350° F. The average humidity level in the one or more heat exchangers is generally about 2-20%. Generally, no forced air flows through the one or more heat exchangers during the heating of the flour. The air is generally naturally drawn into the one or more heat exchangers as the flour flows into and out of the one or more heat exchangers. The residence time of the flour in the one or more heat exchangers is generally about 1-20 minutes.

During the heat-treatment process, the amount of denatured protein in the heat-treated flour caused by the heat treatment process is about 7%-20%.

After the heat-treatment process, the starch granules in the heat-treated flour are intact and discernible, which is indicative of a lack of gelatinization. Generally, less than about 5% of the starch in the flour is gelatinized. During the moisture removal step or heat treatment process, the moisture content of the flour is reduced about 15%-98%, and typically about 60%-98%, and more typically about 80-96%. For example, a flour that includes moisture from about 10%-15% by weight of the flour prior to the heat treatment process is typically reduced to a moisture content of about 1%-6% after the heat treatment process. The moisture content of the heat-treated flour is generally not less than about 1%. The reducing of the moisture to less than about 1% can result in poor dough formation and baked products with unacceptable quality and low Baked Specific Volume (BSV) the baked dough product. The heat-treated flour has a decreased microbial load relative to untreated flour.

After the heat-treatment process, the heat-treated flour generally has a particle size distribution such that greater than 50% of the flour has particles from about 90-150 microns. During the heat treatment process, the average particle size of the flour is generally decreased by about 5-20%.

After the cooling process, the heat-treated flour has an A_{w} of about 0.1-0.5.

The heat-treated flour exhibits an increase in moisture absorption of at least 2% relative to untreated flour.

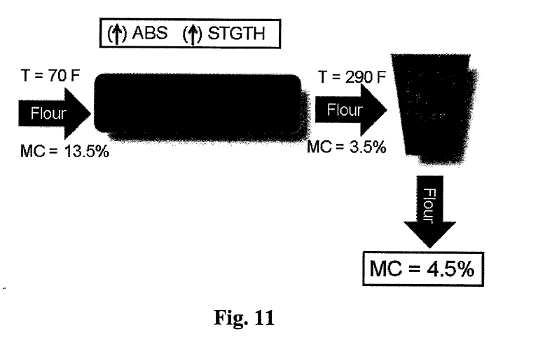

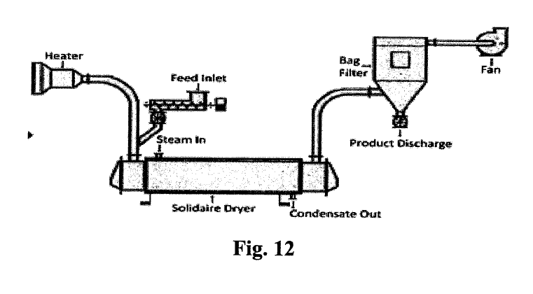

FIGS. 11 and 12 illustrated non-limiting processes and process equipment that can be used to form the heated flour of the present invention. As illustrated in FIG. 11, the flour is inserted at ambient temperature (e.g., 70° F.) into a heat exchanger. The moisture content (MC) of the flour is about 13.5%. The heat-treated flour exits the heat exchanger at a temperature of about 290° F. and has a moisture content of 3.5%. The heat-treated flour is strengthened during the heat treatment process. Also the moisture absorption characteristics of the heated-flour are improved during the heat treatment process. After the flour is heat-treated, the heat-treated flour is cooled and has a final moisture content of about 4.5%. Referring now to FIG. 12, the non-limiting apparatus illustrates the use of a heater to heat the air at the beginning of the heating process. Such a preheating air process is optional. The heat exchanger is illustrated as being heated by steam; however, the heat exchanger can be used by heated oil, electric coils, etc. A single heat exchanger is illustrated; however, it can be appreciated that a series of heat exchangers can be used to heat the flour during the single-step heating process. A bag filter and vacuum and/or blower system can be optionally used to remove/receive the heat-treated flour from the heat exchanger.

Additives can be added to the flour before, during and/or after the heat treatment; however, this is not required. Examples of such additives include, but are not limited to, vitamins, minerals, salts, flavors and enzymes.

The heat-treated flour is generally added to dough to make a variety of food products. The heat-treated flour is generally added in an amount that is less than the amount of the flour in the dough product. Generally, the heat-treated flour constitutes about 0.1 wt %-30 wt % (e.g., 0.1 wt %, 0.101 wt %, 0.102 wt % . . . . 29.998 wt %, 29.999 wt %, 20 wt % and any value or range therebetween) of the baked dough product, typically about 0.25 wt %-20 wt %, more typically about 0.25 wt %-12 wt %, even more typically about 0.5 wt %-10 wt %, and still even more typically about 1-5 wt %. The addition of too large of weight percent of the heat-treated flour to the dough product can adversely affect the quality and taste of the baked dough product. The heat-treated dough of the present invention has also been found to be a substitute for the use of Vital Wheat Gluten (VWG). VWG has been used to strengthen baked dough products. Flour that is used in a dough product can be strengthened by several means, such as by heat, by ozone, by UV exposure, by irradiation, etc. The dough can also or alternatively be strengthened by adding additional wheat protein ingredients, such as VWG or wheat protein fractions, or by enhancing the wheat protein already in the flour by chemical means, such as by use of potassium bromate, azodicarbonamide (ADA), stearoyl lactylates, diacetyl tartaric acid esters of mono- and diglycerides (DATEM), and enzymes, to name a few. The present invention describes and illustrates that, through the use of a farinograph and bake performance data, a low wheat protein dough strengthener and conditioner ingredient can be added as a minor ingredient to the baked dough product to provide strength resulting in comparable bake volume and crumb structure, and tender crumb texture. It has been found that, in several baked dough products, the use of the heat-treated flour as a substitute for VWG results in a better baked dough product. The improved properties of dough (including frozen dough) made from the heat-treated flour include increased moisture absorption, increased strength, decreased adhesiveness, decreased stickiness and/or decreased cohesiveness. The heat-treated flour can be used in high-moisture dough. The moisture absorption, increased strength, shelf-life, tolerance index and/or adhesiveness of dough made from the heat-treated flour of the present invention can result in improved dough products as compared to dough products made from nonheat-treated flour or dough products made from non-heat-treated flour that include VWG. Baked products prepared from the heat-treated flour can have desirable properties (e.g., baked specific volume) relative to those prepared from flour which has not been heat-treated. Baked products that include the heat-treated flour can have the same or higher baked specific volume and/or lower percent solids as compared to baked products made from dough that does not include heat-treated flour.

The dough that includes the heat-treated flour can be frozen. A non-limiting example of a dough useful in the present invention includes flour, water, leavening agent (which may be yeast or chemical leavening agent or both) and, optionally, one or more additional ingredients including, for example, iron, salt, stabilizer(s), flavored oils, enzymes, sugar, niacin, at least one fat source, riboflavin, corn meal, thiamine mononitrate, flavoring(s), and the like.

The steps of baking the frozen dough include thawing the dough, retarding the dough, proofing the dough, and baking the dough. The dough is at least partially thawed by placing the frozen dough for at least one hour (e.g., 1-48 hours and any value or range therebetween) in an environment having a temperature of less than about 50° F. (e.g., 33° F.-45° F.). The dough can be proofed by placing the dough into an environment having a temperature of about 55° F. to 150° F. (e.g., 90° F.-100° F.) having a relative humidity of about 50% to 95% (e.g., 80%-90%) until the dough reaches a desired proofed height. After the dough is proofed, the proofed dough can optionally be rested by placing the dough in an ambient temperature (e.g., 65° F. to 85° F.) for about 1-100 minutes (e.g., 5-15 min). The dough is generally placed on a rack or in a pan and baked at a temperature of at least about 250° F. (e.g., 325° F.-390° F.) for about 5-100 minutes (e.g., 20-40 min.). During the baking process, the dough can optionally be exposed to steam for at least 2 seconds (e.g., 2-20 sec.). The steam process, when used, typically occurs at the beginning of the baking processing.

Non-limiting properties of heat-treated flour formed in accordance with the present invention are set forth in Example 1.

### Example 1

### Strengthened Flour by Heat Treatment

Hard wheat flours at two different protein contents, one at 10.7 wt % and the second at 13.2 wt %, were heat-treated by the process of the present invention. The untreated and heat-treated flours were run in a farinogram, and the results are shown in Table 1.

TABLE 1

| | Untreated Low | Strengthened Low | Untreated High | Strengthened High |
|---|---|---|---|---|
| Farinograph | Protein (10.7%) | Protein (10.8%) | Protein (13.2%) | Protein (13.2%) |
| Parameters | Hard Wheat Flour | Hard Wheat Flour | Hard Wheat Flour | Hard Wheat Flour |
| Moisture (%) | 13.4 | 5.3 | 11.4 | 3.0 |
| Consistency | 497 | 487 | 499 | 492 |
| Water Absorption | 57.7 | 67.2 | 64.4 | 74.8 |
| (corrected for 500 BU) | | | | |
| Water Absorption | 57.0 | 58.0 | 61.4 | 63.4 |
| (corrected for 14% | | | | |
| moisture) | | | | |
| Development time | 2.0 | 6.3 | 6.2 | 10.8 |
| (min.) | | | | |
| Stability (min.) | 8.0 | 24.7 | 11.7 | 25.9 |
| Tolerance index (BU) | 46 | 7 | 25 | 12 |
| Time to breakdown | 4.4 | 26.0 | 12.3 | 29.8 |
| (min.) | | | | |
| Farinograph quality no. | 44 | 260 | 123 | 298 |

The farinogram is a physical test that measures and records the resistance, as torque, of a flour/water mixture. The absorption is the amount of water mixed to a fixed amount of dry solids of flour to center the farinograph curve on the 500-Brabendar Unit (BU) line as a standard consistency to compare flour, either different flours or flours from different crop years. The development time is an indicator from the moment water is added until the dough reaches maximum consistency. Two farinogram properties that are used to evaluate flour strength are stability and mixing tolerance. Stability is a time indicator that the dough maintains maximum consistency and is defined as the difference in time between arrival, which is the time when the resistance curve reaches 500 BU, and departure, which is the time when the resistance curve drops below 500 BU. Mixing tolerance index is the difference in consistency BU value at the top of the curve at peak development time and the consistency value at the top of the curve 5 minutes after peak.

The results in Table 1 show the effect of heat treatment on the increased strength in both flour types, as indicated by increased stability time (which shows the heat-treated flours were able to maintain higher consistency with prolonged resistance until departure than their respective untreated flour) and by lower mixing tolerance (which shows less decrease in consistency after 5 minutes of reaching peak). These two effects define strengthened flour. It is believed that flours other than 10.7 wt % hard wheat flour and 13.2 wt % hard wheat flour can be heat-treated by the process of the present invention to form heat-treated flour having the same or similar properties as the flours set forth above and to produce dough products having improved properties.

Example 2 is a comparison of dough that includes the heat-treated flour of the present invention to dough that includes VWG. The dough that includes the heat-treated flour is identified as strengthened dough.

### Example 2

### Strengthened Flour Using VWG Compared to Using Strengthened Flour

Five different flour samples were run in a farinograph.

Sample 1

Untreated 12.4 wt % protein flour only (control).

Sample 2

Untreated 12.4 wt % protein flour with 3 wt % VWG added (control w/3 wt % VWG)

Sample 3

Untreated 12.4 wt % protein flour with 3 wt % heat-treated flour wherein the heat-treated flour was 10.74 wt % protein flour.

Sample 4

Untreated 12.4% protein flour with 4.5 wt % heat-treated flour wherein the heat-treated flour was 10.7 wt % protein flour.

Sample 5

Untreated 12.4% protein flour with 3 wt % heat-treated flour wherein the heat-treated flour was 13.2 wt % protein flour.

The result of using dough strengthening ingredient, either VWG or SF, to provide overall improved properties to un treated flour is set forth in Table 2.

TABLE 2

| | Control | | Control | Control | Control |
|---|---|---|---|---|---|
| | (Untreated 12.4% | Control | (w/3% Strengthened | (w/4.5% Strengthened | (w/3% Strengthened |
| Farinograph | protein flour) | (w/3% VWG) | 10.7% protein flour) | 10.7% protein flour) | 13.2% protein flour) |
| Parameters | (Sample 1) | (Sample 2) | (Sample 3) | (Sample 4) | (Sample 5) |
| Moisture (%) | 12.4 | 12.2 | 12.2 | 12.2 | 12.2 |
| Consistency | 512 | 519 | 513 | 494 | 492 |
| Water Absorption | 61.8 | 65.5 | 64.8 | 65.4 | 64.8 |
| (corrected for 500 BU) | | | | | |
| Water Absorption | 60.0 | 63.7 | 63.0 | 64.7 | 63.0 |
| (corrected for 14% | | | | | |
| moisture) | | | | | |
| Development time (min) | 2.8 | 4.2 | 2.7 | 2.5 | 3.0 |
| Stability (min) | 11.8 | 19.7 | 13.9 | 17 | 16.0 |
| Tolerance index (BU) | 21 | 7 | 23 | 18 | 9 |
| Time to breakdown (min) | 10.9 | 19.1 | 10.9 | 12.0 | 16.6 |
| Farinograph quality no. | 109 | 191 | 109 | 120 | 166 |

The results in Table 2 illustrate a comparable increase in absorption to a consistency of 500 BU between the VWG containing dough (Sample 2) and the dough containing the heat-treated or strengthened flour (Samples 3-5) when VWG and the strengthened flour were added to the untreated flour. The control flour with VWG (Sample 2) and the control sample with strengthened flour (Samples 3-5) had increased strength (stability) as compared to dough formed only with the control flour. The increase in stability was not quite as high as VWG; however, the stability increased with increased percentage of the strengthened flour (3 wt % vs. 4.5 wt %), as well as strengthened flour formed from a higher protein flour (3 wt % strengthened flour from 10.7% protein flour vs. 3 wt % strengthened flour from 13.2% protein flour).

Baked frozen dough that was formed from dough that includes VWG and dough that includes the heat-treated or strengthened flour is compared in Example 3.

### Example 3

### Frozen Dough Product Bake Evaluation: Use of VWG Compared to Use of Strengthened Flour

The strength of flour and dough is important in frozen dough products during the frozen storage of the dough so as to counter the effects ice re-crystallization on gluten integrity. The required dough strength to maintain quality of the dough during frozen storage is obtained through a combination of high protein wheat flour having high stability and traditional dough strengthening ingredients, such as VWG, potassium bromate, azodicarbonamide (ADA), stearoyl lactylates, and DATEM.

Several baked goods from frozen dough were tested, namely, sweet rolls, whole wheat dinner rolls, and whole wheat bread loaves. These baked goods were made using either VWG (control) or strengthened flour (test). The strengthened flour used was from 10.7% protein hard spring wheat flour.

The formulations of the tested products setting forth the amount of VWG, strengthen flour (SF) and water as given in baker's percentages are set forth in Tables 3-5.

TABLE 3
Sweet Roll

| | VWG | SF |
|---|---|---|
| Ingredients | Containing Dough | Containing Dough |
| Flour | 100 | 100 |
| Vital Wheat Gluten | 3.0 | — |
| Strengthened Flour | — | 4.0 |
| Salt | 1.0-2.0 | 1.0-2.0 |
| Sugar | 10.0-30.0 | 10.0-30.0 |
| Yeast Food | 0.2-0.6 | 0.2-0.6 |
| Dough Conditioners | 1.0-3.0 | 1.0-3.0 |
| Oil | 2.0-6.0 | 2.0-6.0 |
| Yeast (cream) | 4.0-12.0 | 4.0-12.0 |
| Water | 56.7 | 54.7 |

TABLE 4
Whole Wheat Roll

| | VWG | SF |
|---|---|---|
| Ingredients | Containing Dough | Containing Dough |
| Whole Wheat Flour (medium) | 100 | 100 |
| Salt | 1.0-3.0 | 1.0-3.0 |
| Vital Wheat Gluten | 5.0 | — |
| Strengthened Flour | — | 3.0 |
| Sugar | 6.0-12.0 | 6.0-12.0 |
| Yeast Food | 0.2-0.6 | 0.2-0.6 |
| Dough Conditioners | 0.2-0.7 | 0.2-0.7 |
| Oil | 2.0-5.0 | 2.0-5.0 |
| Yeast (cream) | 4.0-12.0 | 4.0-12.0 |
| Water | 52.5 | 49.8 |

TABLE 5
Whole Wheat Bread Loaf

| | VWG | SF |
|---|---|---|
| Ingredient Variable | Containing Dough | Containing Dough |
| Whole Wheat flour (medium) | 100 | 100 |
| Vital Wheat Gluten | 2.5 | — |
| Strengthened Flour | — | 3.0 |
| Salt | 1.0-3.0 | 1.0-3.0 |
| Dough Conditioners | 0.2-0.7 | 0.2-0.7 |
| Yeast Food | 0.2-0.6 | 0.2-0.6 |
| Sugar | 4.0-10.0 | 4.0-10.0 |
| Oil | 2.0-5.0 | 2.0-5.0 |
| Yeast (cream) | 4.0-12.0 | 4.0-12.0 |
| Water | 56.8 | 54.0 |

For each of the above baked products, the frozen dough was removed from the freezer a day prior to baking. The frozen samples for each product were placed on line trays, and the trays were then placed into a retarder cabinet at about 37° F. (2.8° C.) for 15 hours overnight. The samples were then removed from the retarder and, in the case of the whole wheat loaf samples, immediately placed into oil-sprayed loaf pans. The samples were then placed into a proofer cabinet at about 92° F. (33.3° C.) and at about 85% relative humidity until the samples reached a desired proofed height. The samples were then removed from the proofer and allowed 10 minutes of ambient temperature floor time prior to placing the samples in a rack oven to bake. For the sweet rolls, the baking was conducted at about 340° F. (171.1° C.) for about 10 minutes and with about a 10 second steam at the beginning of the baking process. For the whole wheat rolls, the baking was conduct at about 365° F. (185° C.) for about 12 minutes and with about a 7 second steam at the beginning of the baking process. For the whole wheat bread loaf, the baking was conducted at about 375° F. (190.5° C.) for about 25 minutes and with about a 10 second steam at the beginning of the baking process. The baked samples were allowed to cool for at least 1 hour before weight and volume measurements were taken on the TexVol Instrument (model BVM-L450). The VWG and SF samples for each product were retarded, proofed, and baked on the same trays so that such samples experienced the same conditions throughout the proofing and the baking process.

The baked volume and weight measurements for the samples are illustrated in Table 6.

TABLE 6
Baked Volume And Baked Weight Measurements.

| Frozen | | | | | | | | | |
|---|---|---|---|---|---|---|---|---|---|
| Storage | Sweet Roll | | | Whole Wheat Roll | | | Whole Wheat Bread Loaf | | |
| (days) | VWG | SF | Difference | VWG | SF | Difference | VWG | SF | Difference |
| 30 d | | | | | | | | | |
| Volume (mL) | 172.3 | 172.8 | +0.3% | 190.5 | 182.8 | −4.0% | 2866 | 2874 | +0.3% |
| Weight (g) | 35.7 | 35.0 | −2.0% | 36.2 | 35.6 | −1.7% | 445.3 | 450.8 | +1.2% |
| 60 d | | | | | | | | | |
| Volume (mL) | 146.0 | 161.0 | +10.3% | 196.5 | 193.3 | −1.6% | 2805 | 2789 | −0.6% |
| Weight (g) | 33.8 | 35.6 | +5.3% | 35.9 | 36.7 | +2.2% | 448.3 | 445.3 | −0.7% |
| 90 d | | | | | | | | | |
| Volume (mL) | 132.0 | 151.5 | +14.8% | 167.2 | 176.5 | +5.6% | 2770 | 2797 | +1.0% |
| Weight (g) | 32.8 | 35.6 | +8.5% | 35.3 | 37.2 | +5.4% | 448.4 | 451.6 | 0.007 |
| 120 d | | | | | | | | | |
| Volume (mL) | 143.0 | 165.3 | +15.6% | 166.5 | 170.8 | +2.6% | 2868 | 2920 | 0.018 |
| Weight (g) | 34.4 | 36.5 | +6.1% | 35.4 | 35.3 | −0.3% | 442.2 | 450.1 | 0.018 |
| 150 d | | | | | | | | | |
| Volume (mL) | 136.0 | 146.0 | +7.4% | 162.3 | 166.3 | +2.5% | 2703 | 2701 | −0.1% |
| Weight (g) | 33.9 | 34.1 | +0.6% | 35.24 | 36.26 | +2.9% | 454.5 | 453.0 | −0.3% |

Numerical Values are Averages with p<0.05

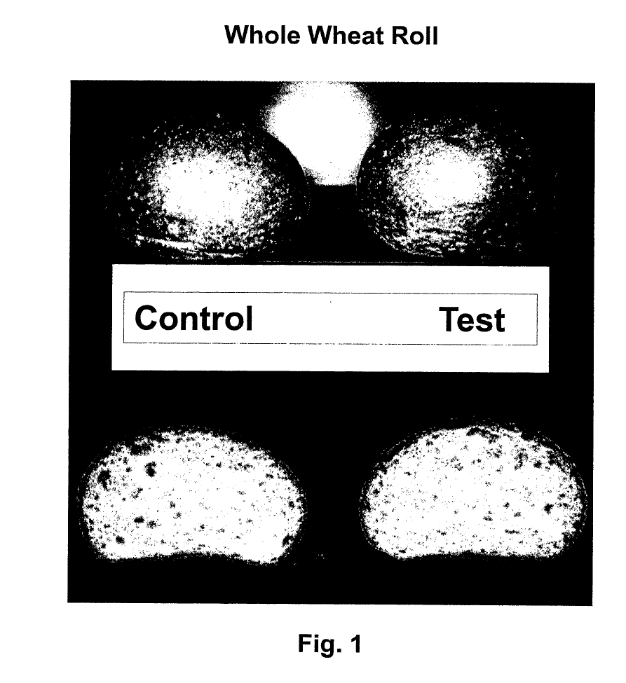

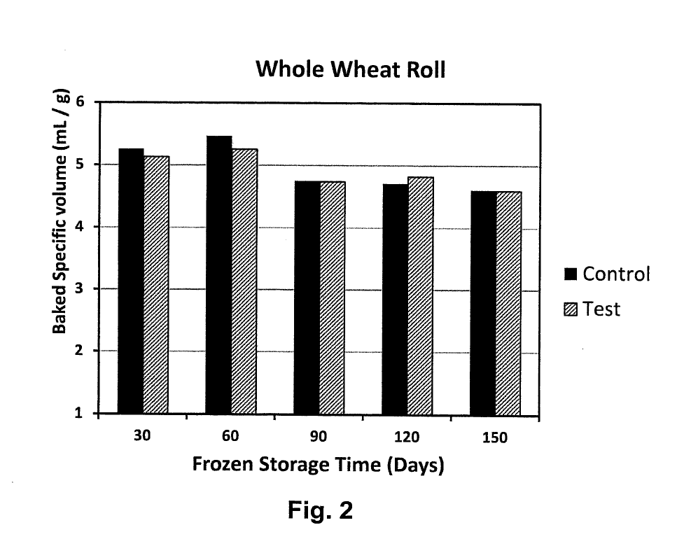

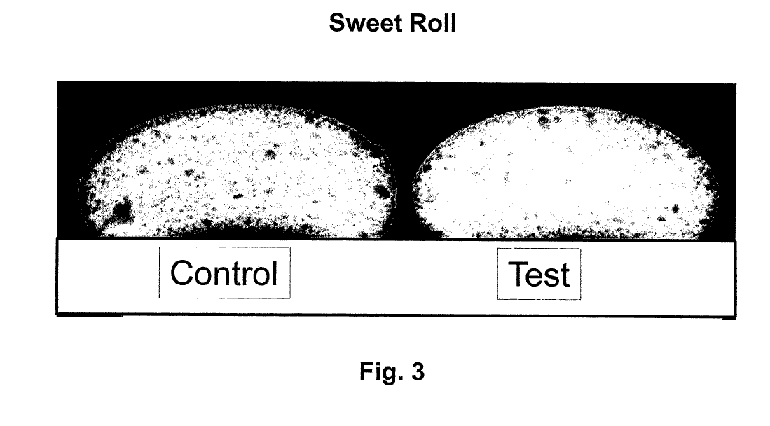

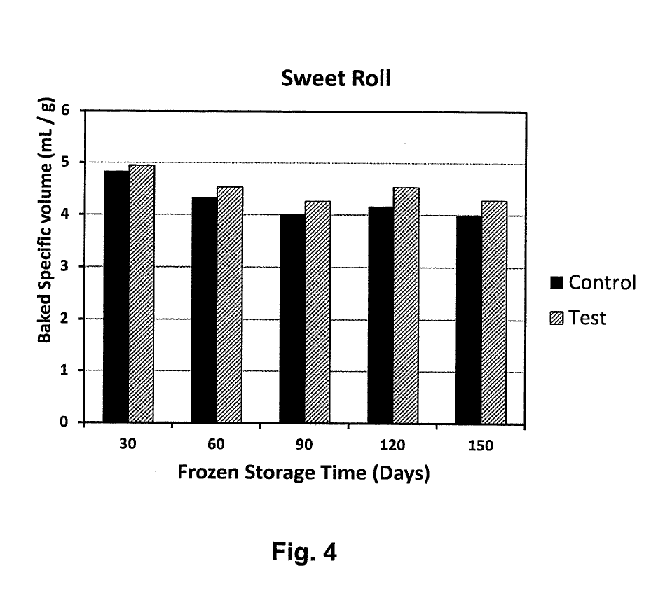

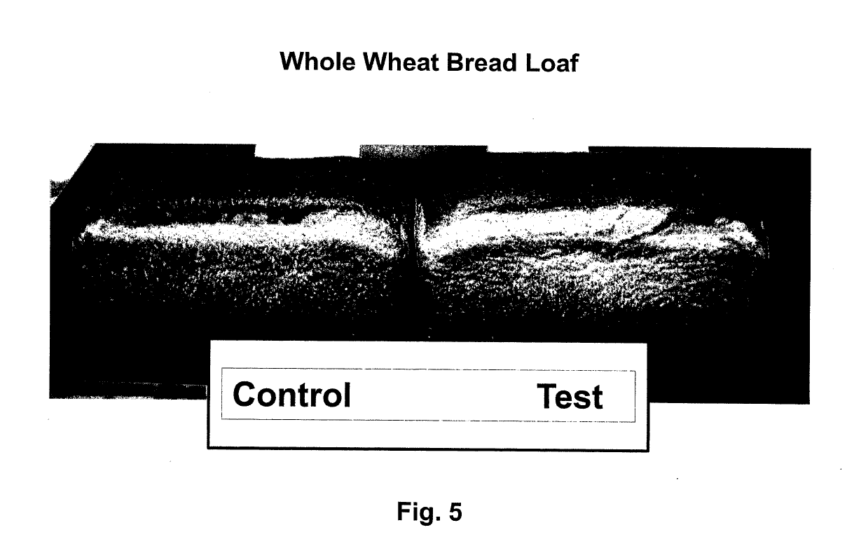

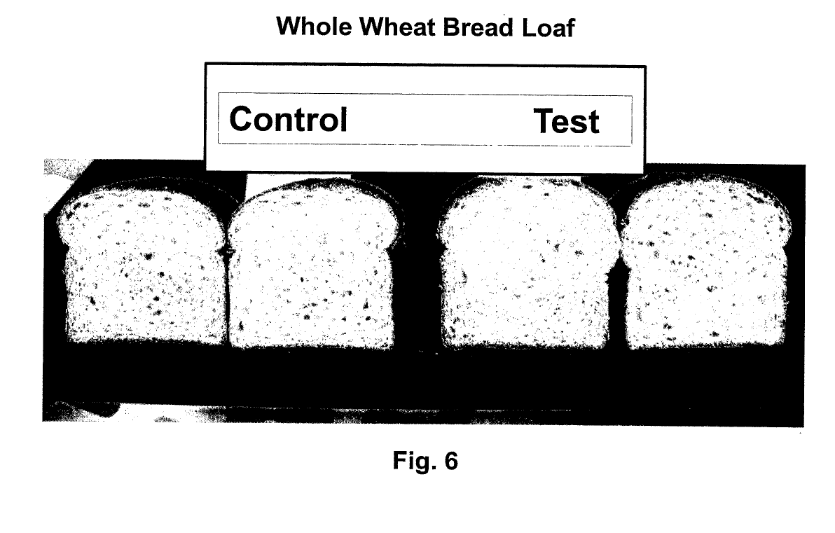

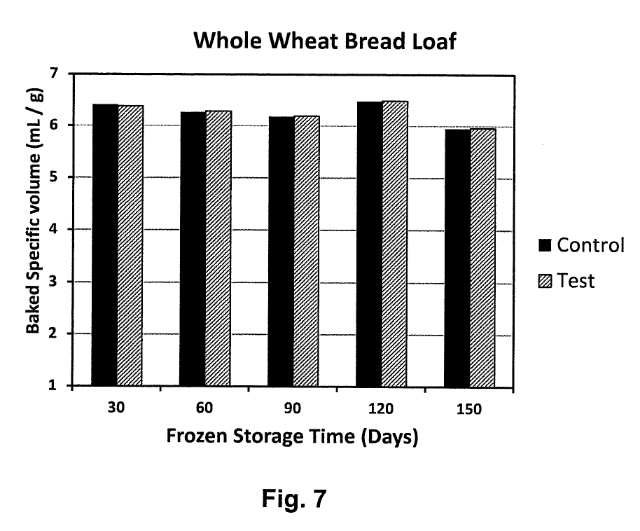

The baked-specific-volume (BSV) for each of these products is illustrated in FIGS. 2, 4 and 7. Illustrations of these products are shown in FIGS. 1, 3, 5 and 6. The BSV is an inverse-density parameter calculated from the baked volume divided by the baked weight, and is commonly used as quality index of the baked performance of a product. Generally, bread products made from a dough that has insufficient strength and/or has poor gluten integrity due to multi-grains or bran in the formulas results in an increased dense crumb structure, and hence has a low BSV. The sweet rolls made with SF had significantly higher BSV and baked volumes than the sweet rolls made with VWG throughout 150 days frozen storage. The whole wheat rolls and whole wheat bread loaves made with SF had comparable BSV and volumes to the whole wheat rolls and whole wheat bread loaves made with VWG throughout 150 days frozen storage. This performance throughout the frozen storage is a very good indicator of how effective SF can be as a dough strengthening ingredient as compared to VWG.

Example 4 is a comparison of different amount of VWG in the dough as compared to a dough that includes SF.

### Example 4

### Frozen Dough Product Bake Evaluation: Optimized VWG Vs. Reduced VWG Vs. Strengthened Flour

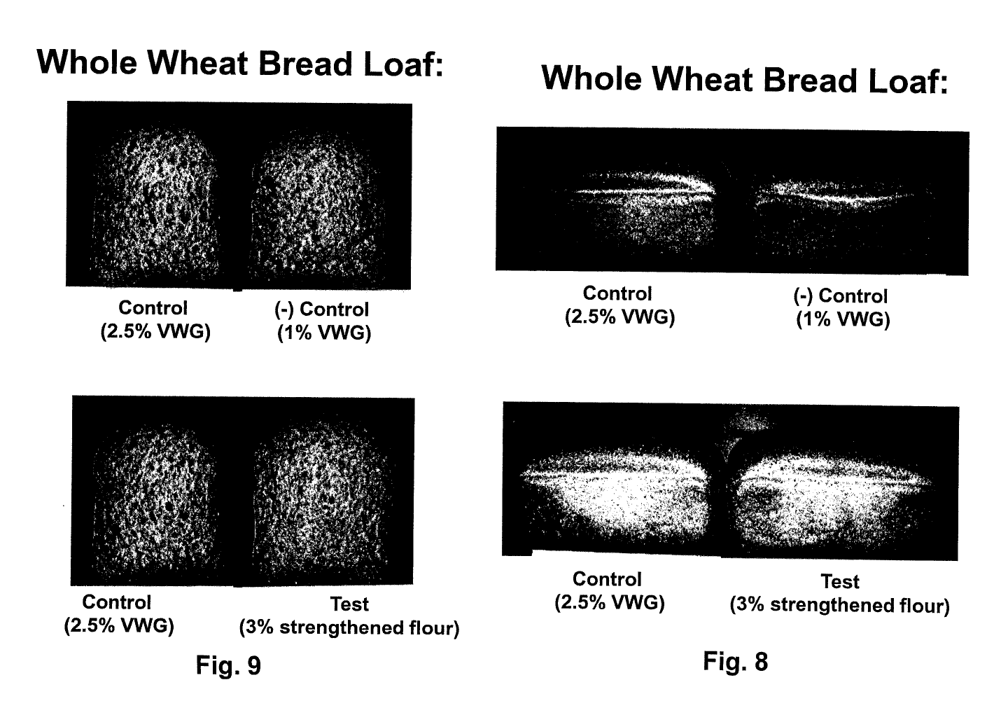

The importance of obtaining the optimum dough strength for a particular baked product is illustrated in FIGS. 8 and 9 and Tables 7-9. Whole wheat breads require additional gluten strength to help with bake volume performance due to the presence of bran in the product. Additionally, frozen dough products need additional strength to counter damaging effects to gluten during the freezing and frozen storage. This example compared whole wheat, frozen dough samples with 2.5% VWG, 1% VWG, and 2.5% SF from 10.7% protein flour. The whole wheat bread samples were about 4 oz. and were proofed and baked in pup loaf bread pans. The dough samples were placed on lined trays, and the trays were placed in a retarder cabinet at about 37° F. for about 15 hours. The samples were then taken out of the retarder and immediately placed into the pup loaf pans and sprayed lightly with canola oil. The samples in the pan were then place into a proofer cabinet at about 92° F. and at about 85% relative humidity. Proofing was complete when the dough height reached about 0.5 cm above the rim of the loaf pan. The proofed samples were given about 10 minute floor time in ambient temperature prior to baking. The samples were then baked in a rack oven at about 375° F. for 16 minutes and with 7 seconds of steam at the beginning of the baking process.

The baked volume and BSV results are shown in Table 7. The bread loaves made from these samples is illustrated in FIGS. 8-9.

TABLE 7
Baked volume and BSV comparison of
4 oz. whole wheat bread samples.

| | Control | (−) Control | Test |
|---|---|---|---|
| | (2.5% VWG) | (1% VWG) | (3% SF) |
| Volume (mL)* | 713 | 687 | 733 |
| BSV (mL/g)* | 7.89 | 7.49 | 8.08 |

*averages based on n = 4 samples.

The negative control samples [(−) Control (1% VWG)] show considerably lower baked volume and BSV as compared to the control [(Control (2.5% VWG)] and the test samples [Test (3% SF)]. The bread loaf profiles illustrate that the negative control samples do not have enough strength as shown by the ‘saddle’ effect where the center of the loaf dips down and is not able to support a desirable ‘domed’ shape loaf. The test samples using SF have better volume and BSV than the control, and the bread loaf and slice profile show comparable characteristics to the control.

Example 5 is a comparison of fresh bake whole wheat bread loaves that include 5% VWG or 5% SF.

### Example 5

### Fresh Bake Whole Wheat Bread Evaluation

Two samples were mixed in a McDuffy-type mixer at 2 minutes low speed and 9 minutes high speed until full gluten development and dough temperature of about 82° F. (28° C.). The control sample included 5% VWG and the test sample included 5% SF based on baker's percent as set forth in Table 8. The dough for each sample was divided into 1 pound (454 g) sample sizes, molded, placed into an oil sprayed loaf pan, and then placed into a proofer cabinet at about 110° F. (43° C.) and about 90% relative humidity for approximately 60 minutes until the dough height reached about 1.5 cm above the rim of the pan. After proofing, the samples were removed and allowed 10 minutes of floor time at ambient temperature before baking. The samples were baked in a rack oven at about 375° F. (190.6° C.) for about 22 minutes and with 12 seconds of steam at the beginning of the baking process. The samples were cooled for at least 1 hour prior to weight and volume measurements.

TABLE 8
Whole Wheat Bread Loaf for Fresh Bake.

Baker's Percent

| Ingredient Variable | Control - VWG | Test - SF |
|---|---|---|
| Whole Wheat flour (medium) | 100 | 100 |
| Vital Wheat Gluten | 5 | — |
| Strengthened Flour | — | 5 |
| Salt | 1.5-2.0 | 1.5-2.0 |
| Dough Conditioners | 2.0-3.0 | 2.0-3.0 |
| Yeast Food | 0.2-0.6 | 0.2-0.6 |
| Sugar | 6.0-8.0 | 6.0-8.0 |
| Oil | 2.5-4.0 | 2.5-4.0 |
| Yeast (compressed) | 3.0-4.0 | 3.0-4.0 |
| Water | 64.5 | 61 |

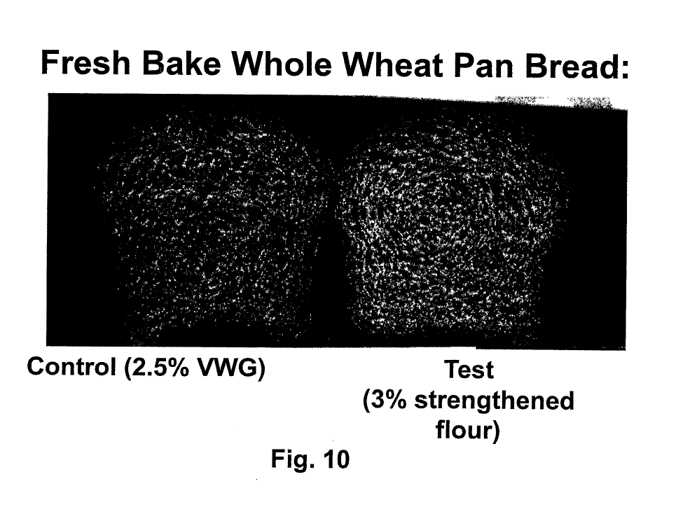

The results of the baked control and test samples are set forth in Table 9. Similar to the sample comparison with frozen dough, the test sample volumes and BSV were similar and within 2% to the control samples. The loaf and cross-sectional slice cut profiles illustrated in FIG. 10 show that the test samples were also similar to the control sample.

TABLE 9
Baked volume and BSV comparison of fresh
bake whole wheat bread loaf samples.

| | Control | Test | |
|---|---|---|---|
| | (5% VWG) | (5% SF) | Difference |
| Volume (mL)* | 1998 | 1963 | −1.8% |
| BSV (mL/g)* | 5.06 | 4.98 | −1.4% |

*averages based on n = 4 samples.

It will thus be seen that the objects set forth above, among those made apparent from the preceding description, are efficiently attained, and since certain changes may be made in the constructions set forth without departing from the spirit and scope of the invention, it is intended that all matter contained in the above description and shown in the accompanying drawings shall be interpreted as illustrative and not in a limiting sense. The invention has been described with reference to preferred and alternate embodiments. Modifications and alterations will become apparent to those skilled in the art upon reading and understanding the detailed discussion of the invention provided herein. This invention is intended to include all such modifications and alterations insofar as they come within the scope of the present invention. It is also to be understood that the following claims are intended to cover all of the generic and specific features of the invention herein described and all statements of the scope of the invention, which, as a matter of language, might be said to fall therebetween.

1-12. (canceled)

13. A method for forming a baked dough product from frozen dough comprising the steps of:
a. providing a dough in frozen form, said dough comprising non-heat-treated flour, heat-treated flour, water and one more additives selected from the group consisting of leavening agent, vitamins, minerals, salts, enzymes, fat, protein, sweetener, preservatives, flavoring agents, starch, emulsifiers and stabilizers, said dough including a majority weight percent non-heat-treated flour and about 0.1 wt % to 30 wt % heat-treated flour, said heat-treated flour has a moisture content of about 1-7%, said heat-treated flour having a moisture content that is 15%-98% less than said non-heat-treated flour, said heat-treated flour has a particle size distribution such that greater than 50% of said heat-treated flour has particles from about 90-150 microns, an amount of denatured protein in said heat-treated flour is about 7%-20%, less than about 5% of starch in said heat-treated flour is gelatinized, and said heat-treated flour has a A_{w} of about 0.1-0.5;
b. at least partially thawing frozen dough;
c. proofing said dough; and,
d. baking said dough to form said baked dough product.

14. The method as defined in claim 13, wherein said step of at least partially thawing frozen dough includes placing said frozen dough for at least one hour in an environment having a temperature of less than about 50° F.

15. The method as defined in claim 13, wherein said step of proofing said dough includes placing said dough that is at least partially thawed into an environment having a temperature of about 55° F. to 150° F. having a relative humidity of about 50% to 95% until said dough reaches a desired proofed height.

16. The method as defined in claim 13, wherein said dough after said step of proofing said dough is placed in an ambient temperature of about 65° F. to 85° F. for about 1-100 minutes.

17. The method as defined in claim 13, wherein said step of baking including placing said dough, after said step of proofing said dough, into an environment having a temperature of at least about 250° F. for about 5-100 minutes, said dough exposed to steam for at least 2 seconds at a beginning of said step of baking.

18. The method as defined in claim 13, wherein said heat-treated flour is formed from one or more flours selected from the group consisting of soft wheat, hard wheat, durum wheat, barley flour, rice flour, corn flour, tapioca flour, potato flour, sorghum flour, buckwheat flour, millet flour, flax flour, pea flour, oat flour and soy flour.

19. The method as defined in claim 13, wherein said dough is absent vital wheat gluten and flour that is strengthened by one or more means selected from the group consisting of chemical means, ozone exposure, UV exposure, and irradiation exposure.

20. A method for forming a baked dough product from dough comprising the steps of:
a. providing a dough in frozen form, said dough comprising flour, water and one or more additives selected from the group consisting of leavening agent, vitamins, minerals, salts, enzymes, fat, protein, sweetener, preservatives, flavoring agents, starch, emulsifiers and stabilizers, said flour in said dough including a mixture of heat-treated flour and non-heat-treated flour, said heat-treated flour has a moisture content of about 1-6%, said heat-treated flour has a moisture content that is about 15%-98% less than said non-heat-treated flour, said heat-treated flour has a particle size distribution such that greater than 50% of said heat-treated flour has particles from about 90-150 microns; and,
b. baking said dough to form said baked dough product.

21. The method as defined in claim 20, wherein said flour in said dough includes over 50 wt % non-heat-treated flour and about 0.1 wt % to about 30 wt % heat-treated flour.

22. The method as defined in claim 20, wherein said flour in said dough includes of over 50 wt % non-heat-treated flour and about 0.25 wt % to about 20 wt % heat-treated flour.

23. The method as defined in claim 20, wherein said flour in said dough includes of over 50 wt % non-heat-treated flour and about 0.5 wt % to about 10 wt % heat-treated flour.

24. The method as defined in claim 20, wherein said dough is frozen, and further including the step of at least partially thawing frozen dough prior to said step of baking said dough.

25. The method as defined in claim 20, further including the step of proofing said dough prior to said step of baking said dough.

26. The method as defined in claim 24, further including the step of proofing said dough prior to said step of baking said dough.

27. The method as defined in claim 20, wherein said non-heat-treated flour has a moisture content of about 10-15 wt %.

28. The method as defined in claim 20, wherein at least about 75% of said heat-treated flour has particles from about 90-150 microns.

29. The method as defined in claim 20, wherein at least about 80% of said heat-treated flour has particles from about 90-150 microns.

30. The method as defined in claim 20, wherein at least about 5% of said heat-treated flour has particles from about 150-250 microns.

31. The method as defined in claim 20, wherein less than about 5% of starch in said heat-treated flour is gelatinized.

32. The method as defined in claim 20, wherein said heat-treated flour has a A_{w} of about 0.1-0.5.

33. The method as defined in claim 20, wherein a particle size distribution of said heat-treated flour is different from a particle size distribution of said non-heat-treated flour.

34. The method as defined in claim 20, wherein an amount of denatured protein in said heat-treated flour is about 5.01%-30%.

35. The method as defined in claim 20, wherein said heat-treated flour exhibits an increase in moisture absorption of 2-15% as compared to said non-heat-treated flour.

36. The method as defined in claim 20, wherein said heat-treated flour formed by the steps of:
i) providing a flour, said flour at ambient temperature of 65-85° F. having a moisture content of about 6%-18%;
ii) thermally heating said flour in a single heat-treating system by continuously moving said flour through said single heat-treating system until said moisture content of said flour is reduced to about 1-6%, a heating temperature and a residence time of said flour is controlled during said step of thermally heating said flour such that said heat-treated flour exits said single heat-treating system at a temperature of about 200-380° F. and said residence time of said flour in said single heat-treating system is about 0.1-60 minutes, said heat-treated flour is exposed to a maximum temperature of about 350° F. during said step of thermally heating said flour, an average humidity level that said heat-treated flour is exposed to during said step of thermally heating said flour is about 2-30%; and,
iii) cooling said heat-treated flour in an environment that minimizes reabsorption of moisture into said heat-treated flour such that the percentage increase in moisture of said heat-treated flour is no more than about 30% and/or the weight percent moisture increase is no more than about 3%, and the final moisture content of said cooled heat-treated flour is about 1-6%.

37. The method as defined in claim 36, including the step of strengthening said heat-treated flour by one or more means selected from the group consisting of chemical means, ozone exposure, UV exposure, and irradiation exposure.

38. The method as defined in claim 36, wherein said step of thermally heating said flour occurs in a heat exchanger as said flour continuously moves through said heat exchanger at a rate of at least 100 lbs./hr.
